(19) United States
(12) Patent Application Publication
(10) Pub. No.: US 2014/0268889 A1
(43) Pub. Date: Sep. 18, 2014

(54) Devices and Methods for Compensating for a Voltage Imbalance Within a Power Supply

(71) Applicants: Matthew Arthur Scott, Vestal, NY (US); Glenn Edward Wilson, Endicott, NY (US)

(72) Inventors: Matthew Arthur Scott, Vestal, NY (US); Glenn Edward Wilson, Endicott, NY (US)

(73) Assignee: ASCO POWER TECHNOLOGIES, L.P., Florham Park, NJ (US)

(21) Appl. No.: 14/204,999

(22) Filed: Mar. 11, 2014

Related U.S. Application Data
(60) Provisional application No. 61/779,835, filed on Mar. 13, 2013.

(51) Int. Cl. H02M 3/24

(52) U.S. Cl. CPC H02M 3/24
USPC 363/15

(57) ABSTRACT

Example devices and methods for compensating for a voltage imbalance within a power supply are provided. In one example, a device comprises a plurality of transformers coupled in series and having respective outputs coupled together, and the plurality of transformers are configured to receive an input voltage. Transformers of the plurality of transformers are configured to receive a capacitor voltage as the input voltage. The device also comprises a control module configured to receive the input voltage as input to each of the plurality of transformers and a feedback signal that includes an output of the series of transformers, and the control module is configured to control switching devices for each of the plurality of transformers so as to control operation of the plurality of transformers to compensate for a voltage imbalance of the voltage across the capacitor.

### BACKGROUND

Microprocessor control of electronic equipment can be performed to efficient use supply power. Example line operated equipment utilizes some form of switching power supply to deliver control power to load circuits. Generally, a switching power supply is an electronic power supply that incorporates a switching regulator to convert electrical power efficiently. Like other power supplies, a switching power supply transfers power from a source to a load, while converting voltage and current characteristics. Typically, a switching power supply is used to efficiently provide a regulated output voltage, usually at a level different from the input voltage.

Within examples, a switching power supply includes a power transistor that is switched between a saturation state (full on) and cutoff (completely off) state, with a variable duty cycle whose average is the desired output voltage. Voltage regulation may be achieved by varying a ratio of on-to-off time of the power transistor. High power conversion efficiency is an advantage of a switched-mode power supply.

### SUMMARY

Within one example, a device is provided that comprises a plurality of transformers coupled in series and having respective outputs coupled together, and the plurality of transformers are configured to receive a capacitor voltage as an input voltage, The device also comprises a control module configured to receive the input voltage as input to each of the plurality of transformers and a feedback signal that includes an output of the series of transformers, and the control module is configured to control switching devices for each of the plurality of transformers so as to control operation of the plurality of transformers to compensate for a voltage imbalance of the capacitor voltage.

In another example, a device is provided that comprises a first transformer configured to receive a first input voltage, and a second transformer coupled in series with the first transformer and having an output coupled together with an output of the first transformer. The second transformer is configured to receive a capacitor voltage as a second input voltage, and the capacitor voltage includes the first input voltage across a capacitor. The device also comprises a control module configured to receive the first input voltage, the second input voltage, and a feedback signal that includes an output of the series of transformers, and the control module is configured to control switching devices for the first transformer and the second transformer so as to control operation of the first transformer and the second transformer to achieve the desired output as well as compensate for a voltage imbalance of the capacitor voltage.

In another example, a method is provided that comprises providing a first input voltage to a first transformer, and providing a capacitor voltage as a second input voltage to a second transformer that is coupled in series with the first transformer. The second transformer is configured to have an output coupled together with an output of the first transformer. The method also comprises based on the first input voltage, the second input voltage, and a feedback signal that includes an output of the series of transformers, controlling switching devices for the first transformer and the second transformer so as to control operation of the first transformer and the second transformer to achieve the desired output as well as compensate for a voltage imbalance of the capacitor voltage.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 illustrates an example system for supplying power.

FIG. 2 is a schematic drawing of an example system for supplying power.

FIG. 3 is a plot diagram of example outputs of the PWM controller in FIG. 2.

FIG. 4 is a schematic drawing of another example system for supplying power.

FIG. 5 is a schematic drawing of an example PWM controller circuit.

FIG. 6 is a flow chart of an example method for compensating for a voltage imbalance within a power supply.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Referring now to the figures, FIG. 1 illustrates an example system 100 for supplying power. The system 100 includes a power supply 102 including a voltage converter 104 and a pulse width modulation (PWM) controller 106, and optionally a processor 108. Line operated equipment may utilize some form of switching power supply to deliver control power to load circuits. The system 100 may be configured to switch power rapidly between a saturation state (full on) and cutoff (completely off) state with a variable duty cycle that has an average as a desired output voltage, for example.

The voltage converter 104 may receive an input voltage (Vᵢₙ), and based on signals from the PWM controller 106, the voltage converter 104 may convert the input voltage to a desired output voltage (Vₒᵤₜ). The voltage converter 104 may include one or more transformers coupled in series and switches for each transformer to control operation of the transformers.

The PWM controller 106 may also receive the input voltage (Vᵢₙ), and generate a duty cycle of pulses to control operation of the voltage converter 104 as power demands of a load changes. In other examples, methods other than pulse width modulation may be used to control the duty cycle of the voltage converter 104, such as variable frequency control like fixed pulse width (on-time) variable frequency control or variable pulse width (on-time) variable frequency control. The PWM controller 106 may take the form of a processor, for example, and may be internal to the power supply 102.

In some examples, the system 100 also includes the processor 108, which may be configured to provide additional information to the PWM controller 106 to control operation of the power supply 102. Alternatively, the processor 108 may encompass functions of the PWM controller 106, which may be removed, and the power supply 102 may include the voltage converter 104 that is coupled to the processor 108 which is a separate component from the power supply 102.

The system 100 may be configured to operate as a stacked flyback voltage converter, in which multiple voltages may be output by controlling operation of components of the voltage converter 104. For example, enabling an additional transformer, diode and capacitor within the voltage converter 104 per output can cause a different voltage output.

FIG. 2 is a schematic drawing of an example system 200 for supplying power. The system 200 may take the form of a power supply, such as the power supply 102 illustrated in FIG. 1. The system 200 includes a first transformer 202 coupled to a switching device 206, and a second transformer 206 coupled to a switching device 208. The first transformer 202 is coupled in series to the second transformer 204, and the switching devices 204 and 208 are operated to control operation of the first transformer 202 and the second transformer 206. The system 200 also includes a PWM controller 210 that provides control signals to the switching devices 204 and 208.

In one example, each of the first transformer 202 and the second transformer 206 includes a primary winding, a core, and a secondary winding. The primary winding has a first terminal and a second terminal, and the secondary winding also has a first terminal and a second terminal. Each of the first transformer 202 and the second transformer 206 may be operated using the respective switching devices 204 and 208. Thus, the system 200 includes multiple magnetic elements, each of which has a magnetic core and primary coils. In addition, each of the first transformer 202 and the second transformer 206 are positioned between respective switching devices 204 and 208 and the output capacitor 220, and each of the first transformer 202 and the second transformer 206 may be independently operated (turned on or off).

The system 200 receives a positive voltage input (Vᵢ₊) and a negative voltage input (Vᵢ₋). The first transformer 202 receives a voltage across a capacitor 212 and the second transformer 206 receives a voltage across a capacitor 214, and may be referred to as a capacitor voltage (V_{cap}). The PWM controller 210 receives the input voltage as input to each of the first transformer 202 and the second transformer 206 including the positive voltage input (Vᵢ₊) and the capacitor voltage (V_{cap}).

The system 200 further includes another capacitor 214 coupled in series with the capacitor 212 and the negative voltage input (Vᵢ₋). The capacitors 212 and 214 may be identical, and may have the same capacitance, for example. The first transformer 202 is coupled to a diode 216 and the second transformer is coupled to a diode 218, and outputs of the first transformer 202 and the second transformer 206 are coupled across an output capacitor 220 to provide a positive and negative output voltage (Vₒ₊) and (Vₒ₋).

The PWM controller 210 also receives a feedback signal, and based on the V_{cap}, Vᵢₙ, and a feedback signal, outputs signaling to the switching device 204 of the first transformer 202 (PWM 1) and to the switching device 208 of the second transformer 206 (PWM 2) to control operation of the first transformer 202 and the second transformer 206. The feedback signal may be a voltage or current feedback from an output of the system 200, and the feedback signal can be used to set an overall duty cycle of the switching devices 204 and 208.

In an example operation of the system 200, when the switching device 204 is closed, a primary winding of the first transformer 202 is connected to the input voltage, and as the primary current and magnetic flux in the first transformer 202 increases, energy is stored in the first transformer 202. Voltage induced in a secondary winding of the first transformer 202 is negative, so the diode 216 is reverse-biased (i.e., blocked). The output capacitor 220 supplies any stored energy in the output capacitor 220 to an output load. When the switching device 204 is opened, the primary current and magnetic flux drops, and the secondary winding voltage is positive, forward-biasing the diode 216, and allowing current to flow from the first transformer 202. Energy from the first transformer 202 recharges the output capacitor 220 and also supplies any load. Operation of the second transformer 206 may be similar to the first transformer 202, and may be concurrent with the first transformer 202.

Operation of storing energy in the first transformer 202 and the second transformer 206 before transferring to the output of the converter allows the system 200 to generate multiple voltage outputs, as the number of transformers in the system 200 are turned on and off. The PWM controller 210 controls which of the first transformer 202 and the second transformer 206 are on or off with the PWM 1 and PWM 2 signaling. Thus, in some examples, when a voltage input is low, the switching devices 204 and 208 may be controlled to short out transformer(s) and capacitor(s), e.g., such as either or both of capacitors 212 and 214.

The system 200 in FIG. 2 illustrates a dual switch realization of the power supply as an example implementation with two magnetic elements in series (i.e., the first transformer 202 and the second transformer 206) with their outputs coupled together. The PWM controller 210 has connections to the input voltage, the intermediate capacitor voltage, and a feedback signal, and outputs control signals to the switching devices for each magnetic element. The PWM controller 210 is configured to control operation of the first transformer 202 and the second transformer 206 to achieve the desired output as well as compensate for a voltage imbalance of the capacitor voltage (V_{cap}).

As another specific example, the PWM controller 210 is configured to compensate for voltage imbalances of a capacitor bank (including the capacitors 212 and 214). Because each of the first transformer 202 and the second transformer 206 has independent switching capabilities, the PWM controller 210 may be configured to split the transformers into multiple units.

As an example, the capacitors 212 and 214 may comprise a capacitor bank electrically connected across an input voltage. The capacitor 212 may power the first transformer 202 (e.g., the primary coil of the first transformer 202) and the capacitor 214 may power the second transformer 206 (e.g., the primary coil of the second transformer 206). The PWM controller 210 is configured to control the switching devices 204 and 208, such that in normal operation both of the switching devices 204 and 208 are turned on simultaneously. In examples of a detected imbalance, the PWM controller 210 can control one of the switching devices 204 and 208 to remain on longer to compensate for the imbalance in one of the capacitor output voltages.

In one example, the PWM controller 210 may be configured to determine any voltage imbalance present in the capacitor bank including the capacitors 212 and 214 by comparing the voltages. In an example in which the PWM controller 210 includes a digital processor, the processor may be configured to receive the input voltage and the V_{cap} and perform a comparison. In an example in which the PWM controller 210 takes the form of an analog circuit, the PWM controller 210 may be configured as described below with reference to FIG. 5.

FIG. 3 is a plot diagram of example outputs of the PWM controller 200 in FIG. 2. The diagram illustrates that within a first period, a first positive pulse output for each of PWM 1 and PWM 2 is provided indicating that operation of the first transformer 202 and the second transformer 206 is in unison under normal operation. At a second period, a second pulse shows that the PWM 2 signal is held high for a longer time period, resulting in the second transformer 206 remaining on for a longer duration than the first transformer 202 during the second period. Thus, during the second period, by holding the second transformer 206 on for a longer duration a voltage imbalance at V_{cap} can be corrected to discharge the capacitor 214 for a longer duration, and to compensate for any drift of the V_{cap}. Thus, during the second period, a voltage sharing is performed when the PWM controller 210 senses that V_{cap} is above a centered threshold, and the switching device 208 is held in an on state longer than the switching device 204 to remove energy and re-center the V_{cap} voltage. Within some examples, operation of the system 200 in this manner places little to no amount of ripple on the capacitors 212 and 214. Voltage sharing may configure an output voltage width or ratio, or difference in width of output voltage, for example.

The PWM controller 210 may be configured to detect a voltage imbalance at V_{cap}, for example, a voltage imbalance may be determined based on the V_{cap} being outside of a range of voltages. The range may be a range substantially at (or near) a voltage centered between the positive voltage input (Vᵢ₊) and the negative voltage input (Vᵢ₋), for example.

FIG. 4 is a schematic drawing of another example system 400 for supplying power. The system 400 includes a plurality of transformers 402a-n, each coupled to a respective switching device 404a-n, and each being coupled in series and having an output coupled together. The system 400 includes a PWM controller 406 that provides a PWM signal to each of the switching devices 404a-n to control operation of the plurality of transformers 402a-n. Each of the plurality of transformers 402a-n receives a positive voltage input (Vᵢ₊) and the negative voltage input (Vᵢ₋). Input voltages to the second, third, and so on transformers (i.e., transformers 402b-n) are across a respective input capacitor 408a-n. Each of the plurality of transformers 402a-n are coupled to a respective diode 410a-n, and an output of the system 400 is provided across an output capacitor 412.

The system 400 operates in a similar manner to the system 200 in FIG. 2. The system 400 may be configured as a multi-switch power supply in which any number of magnetic elements and switches can be placed in series to achieve a desired input voltage rating. The PWM controller 406 can be expanded to include inputs for all voltage sharing nodes in the system 400 and can provide outputs for all switches 404a-n based on any voltage imbalance detected among the voltage sharing inputs, for example. As an example, the PWM controller 406 may control operation of the plurality of transformers 402a-n to cause any input capacitors 408a-n to dissipate energy to compensate for any detected voltage imbalances across the capacitors 408a-n, such as based on a voltage across an input capacitor increasing above a threshold.

The system 400 can be configured to operate, based on a given input voltage, to shunt a section (or turn off one or more transformers). For example, for lower input voltage or sags in the input voltage, fewer transformers may be utilized.

FIG. 5 is a schematic drawing of an example PWM controller circuit 500. The circuit 500 includes a voltage sharing module 502 coupled to a first control module 504, and a duty cycle generation module 506 coupled to a second control module 508. The first control module 504 and the second control module 508 each output to a PWM/level shift switch drive circuit 510. The drive circuit 510 receives a clock signal from a main clock 512 and outputs a PWM 1 and PWM 2 signaling. The circuit 500 may be used in the system 200 in FIG. 2 as the PWM controller 210 or in the system 400 in FIG. 4 as the PWM controller 406, for example. The circuit 500 may be an example implementation of an analog control circuit (in contrast to use of a digital processor), for example.

The voltage sharing module 502 includes a first operational amplifier 514 that receives a capacitor voltage and a center voltage. The capacitor voltage may be a voltage from the V_{cap} node, as shown in FIG. 2, and the center voltage may be derived from a resistive divider on the input voltage to the system 200 in FIG. 2. The operational amplifier 514 is configured with a negative feedback signal, which is shown as a voltage input. The voltage sharing module 502 is configured to produce a signal that indicates if the capacitor voltage is above or below the center voltage, for example.

The duty cycle generation module 506 includes a first operational amplifier 516 that receives a reference signal (e.g., an internal or external reference voltage that chooses a desired output voltage), and a feedback signal that may be the feedback signal shown in FIG. 2. The duty cycle generation module 506 is configured to produce a signal that signifies if the feedback signal is above or below the reference signal, and therefore, is indicative of whether an output voltage is correct. The first control module 504 includes an operational amplifier 518 configured with feedback, and the first control module 504 is configured to combine outputs of the duty cycle module 506 and the voltage sharing module 502 in a positive sum to control a first switch and output an S1 control signal. The second control module 508 includes an operational amplifier 520 configured with feedback, and the second control module 508 is configured to combine outputs of the duty cycle module 506 and the voltage sharing module 502 in a difference to a second switch and output an S2 control signal.

The drive circuit 510 may be configured to receive the S1 control singal and the S2 control signal, and provide a pulse width modulated output signal (PWM 1 and PWM 2) to each of the switching devices for a first transformer and a second transformer, as shown in FIG. 2, for example. The circuit 500 may change the input analog signal into a PWM signal that has also been shifted to drive switching devices for the transformers.

In one example, the PWM signals are directed to control operation of transformers to correct for any imbalance determined in the capacitor voltage. To correct for imbalance, primary power can be taken off a capacitor to bring a voltage across the capacitor within limits, for example

As one example, if an output voltage increased too high and the capacitor voltage became high as well, the voltage sharing module 502 would produce a lower signal than a previous output and the duty cycle module 506 would also produce a lower signal than a previous output. The first control module 504 would receive the two lower signals and add the two lower signal together to obtain a lower control voltage for a first switch, which translates to the first switch being on for a shorter amount of time. The second control module 508 would receive the low voltage sharing signal, but would produce a higher output because the low signal is applied to a negative input. Within the second control module 508, the output of the duty cycle module 506 is applied to a positive input and may result in a higher or lower signal than before. However, that signal will be higher than the Si signal which will result in the second switch on longer than the first switch and the voltage imbalance can be corrected.

FIG. 6 is a flow chart of an example method 600 for compensating for a voltage imbalance within a power supply. Method 600 shown in FIG. 6 presents an embodiment of a method that could be used by the system 200 in FIG. 2, the system 400 in FIG. 4, the circuit 500 in FIG. 5, or components of any of the above, for example. It should be understood that for this and other processes and methods disclosed herein, the flowchart shows functionality and operation of one possible implementation of present embodiments. In this regard, each block or portions of blocks may represent a module, a segment, or a portion of program code, which includes one or more instructions executable by a processor or computing device for implementing specific logical functions or steps in the process. The program code may be stored on any type of computer readable medium, for example, such as a storage device including a disk or hard drive. The computer readable medium may include non-transitory computer readable medium, for example, such as computer-readable media that stores data for short periods of time like register memory, processor cache and random access memory (RAM). The computer readable medium may also include non-transitory media, such as secondary or persistent long term storage, like read only memory (ROM), optical or magnetic disks, or compact-disc read only memory (CD-ROM), for example. The computer readable media may also be any other volatile or non-volatile storage systems. The computer readable medium may be considered a computer readable storage medium, for example, or a tangible storage device.

In addition, for the method 600 and other processes and methods disclosed herein, each block may represent circuitry that is wired to perform the specific logical functions in the process. Alternative implementations are included within the scope of the example embodiments of the present disclosure in which functions may be executed out of order from that shown or discussed, including substantially concurrent or in reverse order, depending on the functionality involved, as would be understood by those reasonably skilled in the art.

At block 602, the method 600 includes providing a first input voltage to a first transformer. At block 604, the method 600 includes providing a capacitor voltage as a second input voltage to a second transformer that is coupled in series with the first transformer. The second transformer is configured to have an output coupled together with an output of the first transformer, and the capacitor voltage includes the first input voltage across a capacitor.

At block 606, the method 600 includes based on the first input voltage, the second input voltage, and a feedback signal that includes an output of the series of transformers, controlling switching devices for the first transformer and the second transformer so as to control operation of the first transformer and the second transformer to compensate for a voltage imbalance of the capacitor voltage.

Within examples, any of the system 200 in FIG. 2 and the system 400 in FIG. 4 may be operated according to functions described in the method 600 of FIG. 6.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

What is claimed is:

1. A device comprising:
a plurality of transformers coupled in series and having respective outputs coupled together, wherein the plurality of transformers are configured to receive a capacitor voltage as an input voltage; and
a control module configured to receive the input voltage as input to each of the plurality of transformers and a feedback signal that includes an output of the series of transformers, wherein the control module is configured to control switching devices for each of the plurality of transformers so as to control operation of the plurality of transformers to achieve a desired output voltage as well as to compensate for a voltage imbalance of the capacitor voltage.

2. The device of claim 1, wherein the control module is configured to control operation of the plurality of transformers to cause the capacitor voltage to be approximately centered between a positive and a negative voltage input.

3. The device of claim 1, wherein based on the capacitor voltage increasing above a threshold, the control module is configured to control operation of the plurality of transformers to cause the capacitor to dissipate energy to compensate for the voltage imbalance of the capacitor voltage.

4. The device of claim 1, wherein the control module is a digital processor configured to perform functions to control switching devices for each of the plurality of transformers so as to control operation of the plurality of transformers to compensate for the voltage imbalance of the capacitor voltage.

5. The device of claim 1, wherein the control module comprises:
a duty cycle generation module configured to receive a reference signal indicative of a desired output voltage of the plurality of transformers and the feedback signal, wherein the duty cycle generation module is configured to output a duty cycle signal to control the switching devices for each of the plurality of transformers; and
a voltage sharing module configured to receive the capacitor voltage and a center voltage based on a voltage approximately centered between a positive and a negative voltage input, wherein the voltage sharing module is configured to provide an output indicative of an identification of the voltage imbalance of the capacitor voltage,
wherein the control module is configured to receive the duty cycle signal and the output from the voltage sharing module and to provide a pulse width modulated signal to drive the switching devices for each of the plurality of transformers.

6. The device of claim 1, wherein the control module is configured to provide a pulse width modulated output signal to each of the switching devices for each of the plurality of transformers so as to control operation of the plurality of transformers.

7. The device of claim 1, wherein the plurality of transformers are configured to receive a. positive and a negative input voltage, and wherein the control module is configured to control switching devices for each of the plurality of transformers so as to cause the capacitor voltage to be approximately centered between the positive and the negative input voltage.

8. The device of claim 1, wherein the plurality of transformers includes a first transformer and a second transformer, and wherein based on the voltage imbalance being present, the control module is configured to cause one of the first and second transformer to remain on to compensate for drift.

9. A device comprising:
a first transformer configured to receive a first input voltage;
a second transformer coupled in series with the first transformer and having an output coupled together with an output of the first transformer, wherein the second transformer is configured to receive a capacitor voltage as a second input voltage, wherein the capacitor voltage includes the first input voltage across a capacitor; and
a control module configured to receive the first input voltage, the second input voltage, and a feedback signal that includes an output of the series of transformers, wherein the control module is configured to control switching devices for the first transformer and the second transformer so as to control operation of the first transformer and the second transformer to achieve a desired output voltage as well as to compensate for a voltage imbalance of the capacitor voltage.

10. The device of claim 9, wherein the control module is configured to control operation of the first transformer and the second transformer to cause the capacitor voltage to be approximately centered between a positive and a negative voltage input.

11. The device of claim 9, wherein the control module is a digital processor configured to perform functions to control switching devices for the first transformer and the second transformer so as to control operation of the first transformer and the second transformer to compensate for the voltage imbalance of the capacitor voltage.

12. The device of claim 9, wherein the control module comprises:
a duty cycle generation module configured to receive a reference signal indicative of a desired output voltage of the first transformer and the second transformer and the feedback signal, wherein the duty cycle generation module is configured to output a duty cycle signal to control the switching devices for the first transformer and the second transformer.

13. The device of claim 12, wherein the control module further comprises:
a voltage sharing module configured to receive the capacitor voltage and a center voltage that is based on a voltage approximately centered between a positive and a negative voltage input, wherein the voltage sharing module is configured to provide an output indicative of an identification of the voltage imbalance of the capacitor voltage,
wherein the control module is configured to receive the duty cycle signal and the output from the voltage sharing module and to provide a pulse width modulated signal to drive the switching devices for the first transformer and the second transformer.

14. The device of claim 9, wherein the control module is configured to provide a pulse width modulated output signal to each of the switching devices for the first transformer and the second transformer so as to control operation of the first transformer and the second transformer.

15. A method comprising:
providing a first input voltage to a first transformer;
providing a capacitor voltage as a second input voltage to a second transformer that is coupled in series with the first transformer, wherein the second transformer is configured to have an output coupled together with an output of the first transformer; and
based on the first input voltage, the second input voltage, and a feedback signal that includes an output of the series of transformers, controlling switching devices for the first transformer and the second transformer so as to control operation of the first transformer and the second transformer to achieve a desired output voltage as well as to compensate for a voltage imbalance of the capacitor voltage.

16. The method of claim 15, wherein controlling switching devices includes controlling operation of the first transformer and the second transformer to cause the capacitor voltage to be approximately centered between a positive and a negative voltage input.

17. The method of claim 15, wherein the method is performed by a power supply including a digital processor configured to perform functions of controlling the switching devices.

18. The method of claim 15, further comprising based on a reference signal indicative of a desired output voltage of the first transformer and the second transformer and the feedback signal, providing a duty cycle signal to control the switching devices for the first transformer and the second transformer.

19. The method of claim 15, based on the capacitor voltage and a center voltage that is based on a voltage approximately centered between a positive and a negative voltage input, providing an output indicative of an identification of the voltage imbalance of the capacitor voltage.

20. The method of claim 15, wherein controlling switching devices includes providing a pulse width modulated output signal to each of the switching devices for the first transformer and the second transformer so as to control operation of the first transformer and the second transformer.
